(19) United States
(12) Patent Application Publication
(10) Pub. No.: US 2014/0057021 A1
(43) Pub. Date: Feb. 27, 2014

(54) COMPOSITION FOR A CHIA BASED ENERGY DRINK

(71) Applicants: Janice Da Silva, Porto Alegre (BR); Suse Botelho Da Silva, Canoas (BR); Gabriela Raimann, Nova Petropolis (BR)

(72) Inventors: Janice Da Silva, Porto Alegre (BR); Suse Botelho Da Silva, Canoas (BR); Gabriela Raimann, Nova Petropolis (BR)

(21) Appl. No.: 13/965,937

(22) Filed: Aug. 13, 2013

(30) Foreign Application Priority Data
Aug. 24, 2012 (BR) 102012021282-0

(51) Int. Cl. A23L 2/38

(52) U.S. Cl. CPC A23L 2/38
USPC 426/72

(57) ABSTRACT

Composition for an energy drink based on chia seed able to combine the stimulating properties of compounds such as taurine, caffeine and inositol with the anti-oxidizing benefits of the chia seed, retrieving a traditional beverage, “cool chia” in the form of an industrialized product, allowing for the effective use of the combination of raw materials used for the composition of the beverage benefiting health, in terms of neurologic functions, as it is a stimulant, as well as in terms of weight control, as it is an antioxidant and a low-calorie energy source for the body, controlling cholesterol and triglycerides and regulating the intestine.

### BACKGROUND OF THE INVENTION

1. Field of the Invention

The following descriptive report for the present patent application concerns the development of a composition for a drink based on chia able to combine the stimulating properties of compounds such as taurine, caffeine and inositol with the anti-oxidizing benefits of the chia seed, retrieving a traditional beverage, “cool chia”, in the form of an industrialized product.

This composition allows for the effective use of a combination of raw materials used for the composition of the beverage which benefits health, in terms of neurologic functions, as it comprises a stimulant, and in terms of weight control, as it comprises an antioxidant and a low-calorie source of energy for the body, controlling cholesterol and triglycerides and regulating the intestine.

The composition of chia can be compared with that of other mucilaginous seeds such as linseed and psyllium. Unlike linseed, chia does not contain anti-nutritional factors, factors that in linseed constrain its use without preliminary cooking. The anti-nutritional factors consist of cyanogenic glycosides or linatine, which are vitamin B6 antagonists, this actually means they prevent vitamin B6 from acting on metabolism. In addition, chia has a far more pleasant taste than linseed.

2. Description of the Related Art

The use of combinations of extracts derived from vegetables for stimulating neurologic activities and moderating the consumption of calories and regulating digestive functions is widely understood in the prior art.

The high total antioxidant activity (TAA) observed for the chia seed may be attributed to the flavonoids present in the seed, such as myricetin, quercetin, kaempferol, chlorogenic acid and caffeic acid; as well as the effectiveness of the extraction process of the seed compounds for the aqueous extract (MUNOZ et al., 2012; PEIRETTI; GAI, 2009). These compounds are classified as mixed antioxidants that have been widely studied as antioxidants in food. Among these are several hydrolyzed proteins, flavonoids and cinnamic acid derivatives (caffeic acid) (RAMALHO; JORGE, 2006). The total antioxidant activity of the developed chia-based energy drink was established in triplicate by DPPH (1,1-diphenyl-2-picrylhydrazyl) testing, which consists of removing the stable radical DPPH from the reaction medium by the action of the antioxidants available in the sample. After addition of the sample, the discoloration degree of the radical DPPH was measured at 517 nm using a spectrophotometer Bioespectro SP-22 (BORGUINI, 2006; ROCHA; SILVA, 2011).

To conduct the comparative test, an ascorbic acid (Vitamin C) solution was prepared, at the same concentration of the seed in the extract. The analysis of the antioxidant activity of the developed chia-based energy drink resulted in 83.9%±2.0 of TAA, and the result was close to that shown by ascorbic acid (94.7%±0.6), considered to be a natural antioxidant usually added in the formulation of foodstuffs with the purpose to increase their shelf life.

By researching the prior art relative to the technical field of the invention, only patent PI0916752-8 was found, filed with the federal office on Jul. 27, 2008, concerning an invention patent for a chia-based foodstuff made up of fatty acids, rich in Omega-3, with good stability and readily soluble (miscible) in water; however, this property does not clash with any characteristic present in the process in this report.

### SUMMARY OF THE INVENTION

Therefore, due to the considerations relative to the previously reported prior art, one of the objects of the present application for an invention patent is the composition for an energy drink based on chia seed which intends to benefit health, in terms of neurologic functions, as it comprises a stimulant, and in terms of weight control, as it comprises an antioxidant and a low-calorie energy source for the body, controlling cholesterol and triglycerides and regulating the intestine.

These and other objects, features and advantages of the present invention will become clearer when the detailed description is taken into consideration.

### DETAILED DESCRIPTION OF THE PREFERRED EMBODIMENT

The characterization of the invention proposed in this report is done by describing the quantities needed for the composition in question, which are required for the present application, in such a way that it can be fully reproduced by any suitable technique, allowing for the full characterization of the functionality of the patent for which we have applied.

The description of the quantities as a percentage of the individual ingredients comprising the product substantiates the descriptive portion of the report, clarifying aspects that may have been implicit, so as to clearly establish the protection requested herein.

These quantities may have variations, as long as they do not deviate from the initially claimed ratio. In this case, the product can be generated through different formulations.

To obtain 100 ml of the compound, the formulation is achieved by using percentages of the following components:

0.155 g sodium citrate;

0.575 g citric acid;

5 g chia (Salvia hispanica L.);

0.123 g Sicilian lemon aroma;

0.01667 g sucralose;

0.032 g caffeine;

0.4 g taurine;

0.02 g inositol; and

Complex B vitamins:
B2—0.52 mg;
B3—6.4 mg;
B5—2 mg;
B6—0.52 mg; and
B12—0.4 micrograms.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. (canceled)

2. A composition for a chia based energy drink having stimulant and anti-oxidant properties, wherein one-hundred milliliters of said composition comprises:
about 0.155 grams of sodium citrate,
about 0.575 grams of citric acid,
about 5 grams of Salvia hispanica L.,
about 0.123 grams of Sicilian lemon aroma,
about 0.01667 grams of sucralose,
about 0.032 grams of caffeine,
about 0.4 grams of taurine,
about 0.02 grams of inositol, and
a plurality of complex B vitamins including about 0.52 milligrams of vitamin B2, about 6.4 milligrams of vitamin B3, about 2 milligrams of vitamin B5, about 0.52 milligrams of vitamin B6, and about 0.4 micrograms of vitamin B12.
